(19) United States
(12) Patent Application Publication
(10) Pub. No.: US 2007/0222603 A1
(43) Pub. Date: Sep. 27, 2007

(54) Systems and methods for enhancing communication in a wireless communication system

(75) Inventors: Po-Chih Lai, Taizhong (TW); Chia-Jui Shen, Tainan (TW); Ying-Che Lo, Hsinchu (TW); Huan-Chin Luo, Taipei (TW); Kung-Hua Lee, Changhua (TW)

Correspondence Address: BAKER & MCKENZIE LLP;PATENT DEPARTMENT, 2001 ROSS AVENUE, SUITE 2300, DALLAS, TX, 75201, US

(73) Assignee: Macronix International Co., Ltd.

(21) Appl. No.: 11/384,738

(22) Filed: Mar. 20, 2006

(51) Int. Cl. G08B 13/14

(52) U.S. Cl. 340/572.7

(57) ABSTRACT

An RFID system comprises an intermediate device that includes a first and second antenna coils connected together in a close loop format. The first coil can be optimized for communication with a reader, while the second coil can be optimized for communication with a tag. Thus, the dimension of the first antenna coil and the second antenna coil can be completely independent of each other. The intermediate device can be configured such that it can change the direction of the transmission from either the interrogator or the tag, thereby improving communication when the interrogator and tag are not inline.

### BACKGROUND

1. Field of the Invention

The embodiments described herein are directed to radio frequency communication systems, and more particular to systems and methods for extending the communication range in a radio frequency communication system.

2. Background of the Invention

Radio Frequency Identification (RFID) systems are a type of radio frequency communication system. RFID systems are gaining attention due to their ability to track and identify moving objects. In an RFID system, remote objects intended to be tracked and identified are equipped with a small RFID tag. The RFID tag contains a transponder and a digital memory chip that is given a unique electronic identification. An interrogator, or a reader can be configured to emit a signal that can activate the RFID tag. When an RFID tag passes within range of the reader, the RFID tag can detect the reader's signal and provide its identification information. The reader can be configured to decode the identification information, and in certain applications will write data to the RFID tag.

The signal generated by the reader is a Radio Frequency (RF) signal. RFID systems are generally configured to operate within four main frequency bands. The frequency bands are characterized by the frequency of operation for the RF signal generated by the reader. These bands include a low frequency band, i.e., 125 KHz or 134.2 KHz, a high frequency band, i.e., 13.56 MHz, a UHF frequency band, i.e., 868-956 MHz or 463 MHz, and a microwave frequency band, i.e., 2.4 GHz or 5.8 GHz.

An RFID reader generally comprises a radio transceiver configured to transmit and receive RF signal. The radio transceiver is coupled with one or more antennas which enable the transceiver to transmit and receive the RF signals. The transceiver is also interfaced with an encoder/decoder configured to decode information contained in the received signals and encode information to be transmitted via the transceiver.

RFID tags are generally classified as passive or active tags. A passive tag has no internal, or onboard power supply. Instead, a passive tag is powered by energy contained in the RF signal transmitted from the reader. The RF signal transmitted by the reader induces an electrical current in the tag antenna that supplies enough power to allow the tag to power up and transmit a response. Most passive tags signal to the reader by backscattering the RF carrier signal generated by the reader. This means that the tag antenna should be designed to both collect power from the incoming signal and also to transmit the outbound backscatter signal. It should be noted that the response signal generated by the tag can include more than just identification information.

An active tag, on the other hand, includes its own internal power source, which is used to power the tag in order to generate an outgoing signal. Active tags can have longer operational ranges and larger memories as compared to passive tags, which can allow the tag to store additional information sent by the reader; however, because passive tags do not require an onboard power supply, they can be made smaller and can cost significantly less than active tags. Additionally, due to their simplicity in design, passive tags are suitable for manufacture with conventional printing process for the antenna.

While passive tags provide many benefits that make them increasingly more popular for new RFID applications, one drawback is the limited operational range, e.g., as compared to active tags. One way to overcome the limited range problem, in certain applications, is to use a range extender. A range extender can be defined as an antenna, or resonator circuit, that can be placed between the reader and the tag and can be configured to receive the RF signal from the reader, amplify it, and rebroadcast it to the tag. Thus, the resonator circuit can be used to extend the range of communication ordinarily achievable between the reader and the tag.

Conventional range extenders often comprise a single antenna configured for coupling with one of, but not both, the reader or the tag. Consequently, the extension of range can be limited due to the fact that the range extender is not optimized for communication with the other of the reader or the tag. Moreover, conventional range extenders are often only useful for inline communications, i.e., when the reader, the range extender and the tag are all inline with a center orthogonal axis. If the reader and the tag are not so aligned, then conventional range extenders may not provide any advantage.

### SUMMARY

An RFID system comprises an intermediate device that includes a first and second antenna coils connected together in a close loop format. The first coil can be optimized for communication with a reader, while the second coil can be optimized for communication with a tag.

In one aspect, the intermediate device can be configured such that it can change the direction of the transmission from either the interrogator or the tag, thus improving communication when the interrogator and tag are not inline.

In another aspect, the dimension of the first antenna coil and the second antenna coil can be completely independent of each other.

These and other features, aspects, and embodiments of the invention are described below in the section entitled “Detailed Description.”

### BRIEF DESCRIPTION OF THE DRAWINGS

Features, aspects, and embodiments of the inventions are described in conjunction with the attached drawings, in which:

FIG. 1 is a diagram illustrating an example wireless communication system comprising an intermediate antenna in accordance with one embodiment;

FIG. 2 is a diagram illustrating an exemplary wireless communication system;

FIGS. 3A-3D are diagrams illustrating example embodiments of intermediate antennas configured in accordance with different embodiments;

FIG. 4 is a diagram illustrating a wireless communication system comprising an intermediate antenna in more detail;

FIG. 5A is a diagram illustrating a wireless communication system comprising an intermediate antenna in accordance with another embodiment;

FIG. 5B is a diagram illustrating the schematic equivalent of the a portion of the intermediate antenna; and

FIG. 6 is a diagram illustrating a wireless communication system comprising an intermediate antenna configured to change the direction of transmission signals in accordance with one embodiment

### DETAILED DESCRIPTION

The embodiments described below are generally directed to RFID systems and devices; however, it will be understood that the systems and methods described herein can apply to other types of RF communication systems. Accordingly, the embodiments described herein should be seen as examples only and should not be seen as limiting the systems and methods described to any particular type of communications system.

It will also be understood that any dimensions, measurements, ranges, test results, numerical data, etc., are approximate in nature and unless otherwise stated not intended as precise data. The nature of the approximation involved will depend on the nature of the data, the context and the specific embodiments or implementations being discussed.

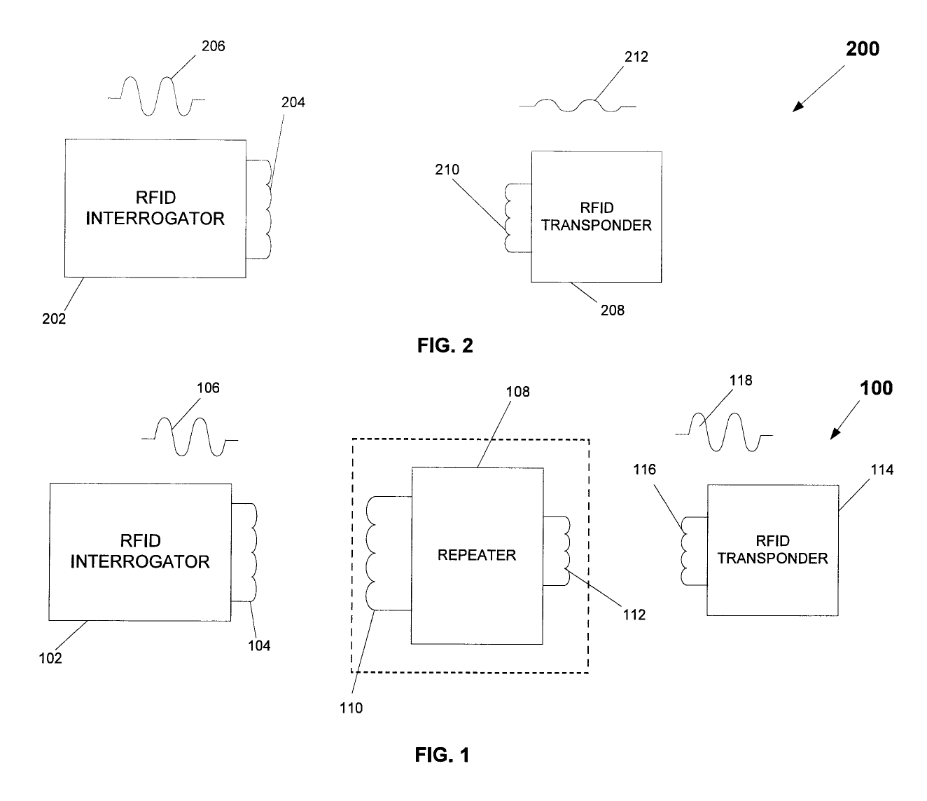

FIG. 1 is a diagram illustrating an RFID system 100 configured to allow communication between an RFID reader, or interrogator 102 and an RFID transponder, or tag 114. As can be seen, RFID interrogator comprises an antenna 104 illustrated as a coil. It will be understood, that an antenna is often represented as an inductive element such as a coil in the manner illustrated in FIG. 1. Similarly, RFID transponder 114 comprises an antenna 116. The dimensions of RFID transponder 114 are often much smaller than interrogator 102. Consequently, antenna 116 will often comprise smaller dimensions than antenna 104.

In operation, RFID interrogator 102 generates a Radio Frequency signal (RF) signal 106 that is transmitted by antenna 104. Signal 106 will propagate through free space and be received by RFID transponder 114; however, under normal operating conditions a signal received by RFID transponder 114 will be attenuated and degraded when it is received.

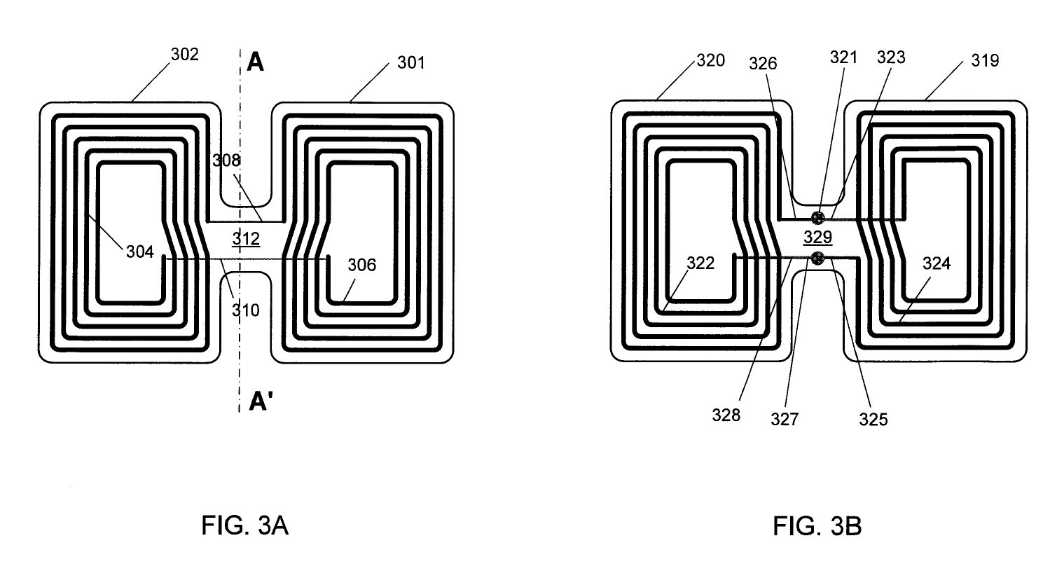

This phenomenon can be illustrated with the aid of FIG. 2 which illustrates a conventional RFID system 200. In system 200, RFID interrogator 202 transmits a signal 206 via antenna 204 and RFID transponder 208 receives signal 212 via antenna 210. Received Signal 212 is attenuated due to dimension mismatch between antenna 204 and antenna 210. Signal 212 can be further attenuated, or interfered with by other wireless communication systems within range of system 200, reflection off of objects between RFID interrogator 202 and RFID transponder 208, etc.

In system 100, signal 106 is received by repeater, or range extender 108 and retransmitted to RFID transponder 114. As can be seen, repeater 108 comprises an antenna 110 configured to receive signal 106, and antenna 112 configured to transmit signal 118. By using repeater 108, signal 106 can be enhanced such that it is a closer replication to signal 106 transmitted via RFID interrogator 102.

As will be described in more detail below, antenna 110 can be designed such that it can optimally couple with antenna 104 in order to optimally receive signals 106. Similarly, antenna 112 can be configured so as to optimally couple with antenna 116 in order to ensure that the an optimum signal 118 is received by RFID transponder 114. By using repeater 108, the power contained in signal 118 can be improved several times compared to a conventional RFID system such as system 200. The improved power can improve error rates and/or increase communication ranges between interrogator 102 and RFID transponder 114.

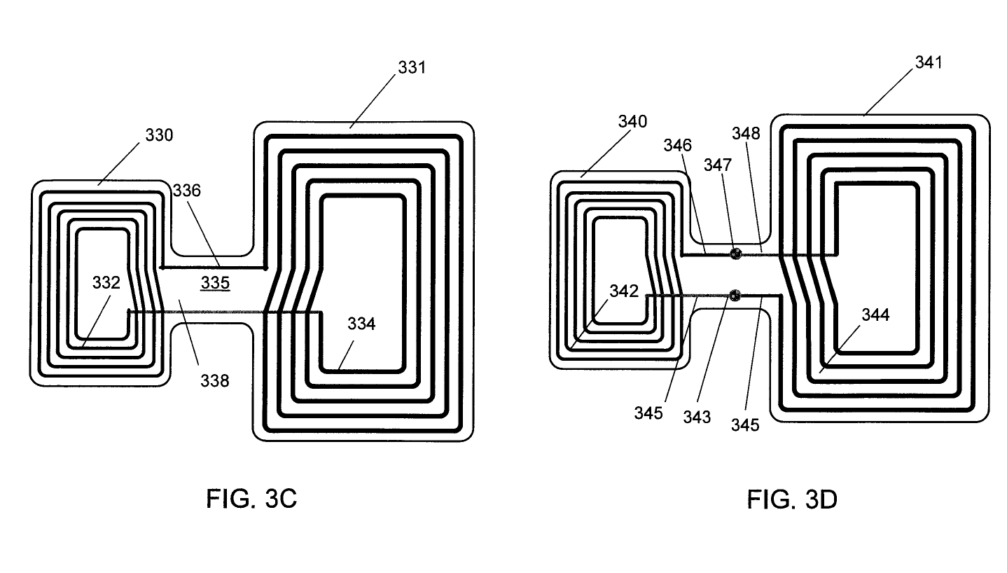

FIG. 3A is a diagram illustrating an intermediate antenna 302 comprising a first coil 304 and a second coil 306. Antenna 302 can be used as a repeater such as repeater 108. Coils 304 and 306 can be formed, for example, on a substrate 301. For example, coils 304 and 306 can be formed from conductive material deposited or formed on substrate 301. The conductive material comprising coils 304 and 306 can be formed on substrate 301 using conventional printed wiring board processing techniques. For example, in embodiments where coils 304 and 306 are fabricated from metal formed on substrate 301, conventional printed wiring board processing techniques can be used. In other embodiments, the conductive material comprising coils 304 and 306 can be formed on substrate 301 using conventional printing processes, such as silk screening.

Substrate 301 can comprise of flexible substrate such as a flexible plastic or metal foil. By using a flexible substrate, antenna 302 can be configured so that it can flex, or bend. For example, antenna 302 can be configured to bend so that the “direction” of communication between a reader and a tag can be changed. This is described in more detail below.

Accordingly, substrate 301 can be constructed from a flexible material and can comprise a thin region 312 and antenna 302 can be configured so as to bend around the axis AA′. In other embodiments, a substrate 301 can comprise a rigid substrate beneath coils 304 and 306 and a flexible substrate in region 312 joining the two more rigid regions.

Substrate 301 can also comprise multiple conductive layers. For example, the top of substrate 301 is clearly a conductive layer comprising coils 304 and 306 and a connection 308 between the two; however, coils 304 and 306 also comprised second terminals that must be connected. These terminals cannot be directly connected on top of substrate 301 because the conductive connection running between the two would cross coils 304 and 306, shorting them out and impairing their performance. Thus, the second terminals of coils 304 and 306 can be connected via a conductive line 310 on the back of substrate 301. In this case, substrate 301 will comprise two conductive layers the top and the back.

It will be understood that in order to connect the terminals of antennas 304 and 306 via conductive line 310 on the back of substrate 301, conductive holes, or vias extending down through substrate 301 and in contact with coils 304 and 306 must be formed. On the back of substrate 301, conductive line 310 can also contact the vias and thereby electrically connect antennas 304 and 306.

In other embodiments, substrate 301 can actually comprised multiple laminated substrates and conductive line 310 can be formed from a conductive layer internal to substrate 301; however, it will be understood that for cost and ease of manufacturing, it is preferable that the only conductive layers on substrate 301 be on the top and bottom of substrate 301.

Coils 304 and 306 are configured so as to comprise two resonant circuits that can receive and transmit RF signal at the appropriate frequencies. Accordingly, the number of turns and dimensions associated with coils 304 and 306 must be configured so that each coil can receive and transmit RF signals at the appropriate frequency.

Further, coils 304 and 306 are configured so that one of the coils, e.g., coil 304 is optimized for coupling with the interrogator, while the other antenna, e.g., is optimized for coupling with the tag. Accordingly, the dimensions of coil 304 can be close to the dimensions of the coil, or antenna included in the reader, while the dimension of coil 306 can be close to the dimensions of the coil, or antenna in the tag. Accordingly, in certain embodiments the dimension of the two coils will differ as seen in some of the embodiments described below.

Coils 304 and 306 are electrically connected via connectors 308 and 310. Thus, when, e.g., an RF signal is impinged upon coil 304, coil 304 will produce an electrical signal that will be coupled via connectors 308 and 310 to coil 306. If coil 306 is constructed properly, then coil 306 will resonate at the appropriate frequency and fully take over the RF signal received by coil 304. In this manner, antenna 302 can act as a range extender.

FIG. 3B is a diagram illustrating another example antenna 120 configured in accordance with another embodiment of the systems and methods describe herein. Antenna 320 comprises a first coil 322 and a second coil 324 formed on a substrate 319. As with substrate 301, substrate 319 can be a flexible substrate, or can at least comprise a flexible region 329. In the example of FIG. 3B, the terminals of antenna 322 and 324 are each connected via a conductive connector on top of substrate 319 and a conductive connector on the bottom of substrate 319, wherein the conductive connectors on top and bottom are connected by vias.

Thus, the first terminal of antenna 322 can be connected to a first terminal of antenna 324 through a conductive connecting line 326 on top of substrate 319 in a conductive connecting line 323 on the bottom of substrate 319. Conductor line 326 and conductor line 323 can then be connected by a via 321. Similarly, a second terminal of antenna 322 can be connected with the second terminal of antenna 324 by a conductive connecting line 328 on the bottom of substrate 319 and a conductive connecting line 325 on the top of substrate 319. Connecting line 328 and connecting line 325 can be connected by via 327.

FIG. 3C is a diagram illustrating an example antenna 330 that comprises coils of different dimensions in accordance with another embodiment of the systems and methods described herein. As can be seen, coil 332 is smaller in dimension than coil 334. It must be kept in mind, however, that the number of coils and dimensions of each coil must still be sufficient to transmit and receive RF signals at the appropriate frequency. Further, the dimension of coil 332 can be configured so as to ensure optimal coupling with a tag, or transponder, while the dimensions of coil 334 can be configured so as to ensure optimal coupling with a reader. Accordingly, the dimension of coil 332 can close to the dimension of an antenna included in the tag, while the dimensions of coil 334 can be close to the dimensions of the antenna included in the reader.

In the example of FIG. 3C, the first terminal of coil 332 is connected with the first terminal of coil 334 via connecting line 336 on top of substrate 331. The second terminal of coil 332 is connected to a second terminal of coil 334 by a connecting line 338 on the bottom of substrate 331. Connecting line 338 can be connected with the terminals of coils 332 and 334 by vias extending through substrate 331.

FIG. 3D is a diagram illustrating an example embodiment of antenna 340 comprising coils of different dimensions configured in accordance with another embodiment of the systems and methods described herein. In the example of FIG. 3D, coil 342, which is smaller than coil 344, is interfaced with the terminals of coil 344 by connecting line 346 on top of substrate 341, via 347, and connecting line 348 on the bottom of substrate 341. The other terminal of coil 342 is connected with the other terminal of coil 344 by conducting line 345 on the bottom of substrate 341, via 343, and connecting line 345 on the top of substrate 341.

Again the dimension of coil 342 can be selected so as to ensure optimal coupling with a tag, while the dimensions of coil 334 can be selected to ensure optimal coupling with a reader.

The examples on FIGS. 3A-3D illustrate several examples of embodiments of intermediate antennas configured in accordance with the systems and methods described herein. It will be understood, however, that other embodiments are possible. For example, in other embodiments antennas configured in accordance with the systems and methods described herein can comprise coils of varying dimensions and shapes. Again, however, the shapes and dimensions should be selected so as to ensure optimal coupling with the associated reader and tag.

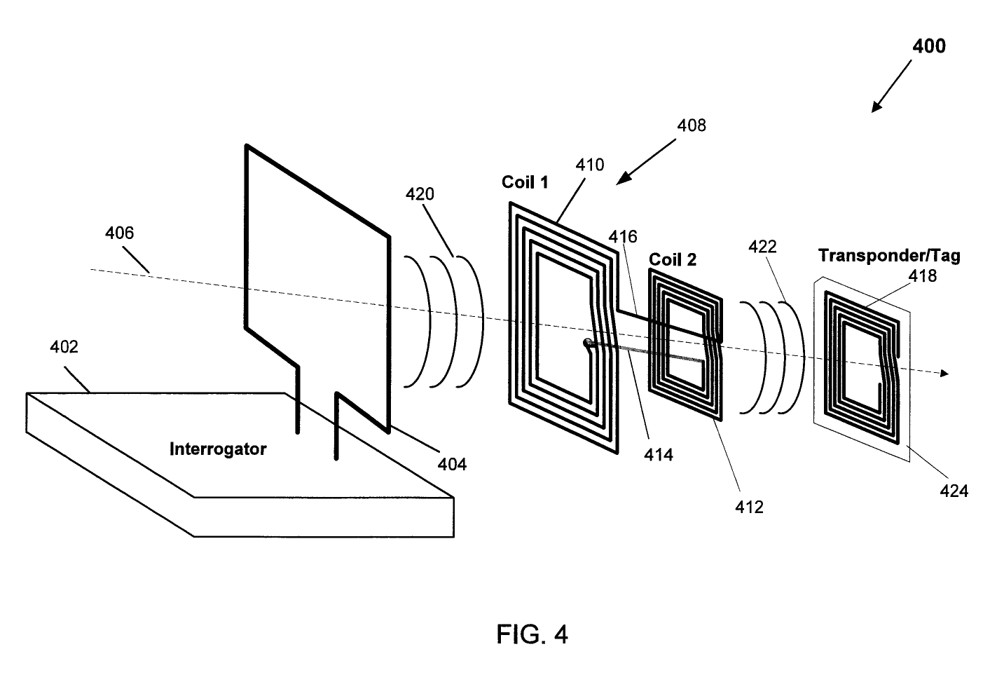

FIG. 4 is a diagram illustrating an RFID system 400 configured to allow communication between an interrogator 402 and a tag 418. Interrogator 402 comprises a transceiver circuit coupled with an antenna 404. Interrogator 402 can be configured to transmit RF signals 420 via antenna 404. RF signals 420 are intended for tag 418; however, RF signals 420 would normally experience attenuation. An intermediate antenna 408 has been placed inline with reader 402.

Intermediate antenna 408 comprises a first coil 410 configured to optimally couple with antenna 404, and a coil 412 configured to be optimally coupled with antenna 424 on tag 418. Thus, RF signals 420 will be impinged upon coil 410, which will cause an electric signal to flow in coil 410 that will be coupled with coil 412. The current will cause coil 412 to resonate and generate an RF signal 422 that can be transmitted to and received by antenna 424.

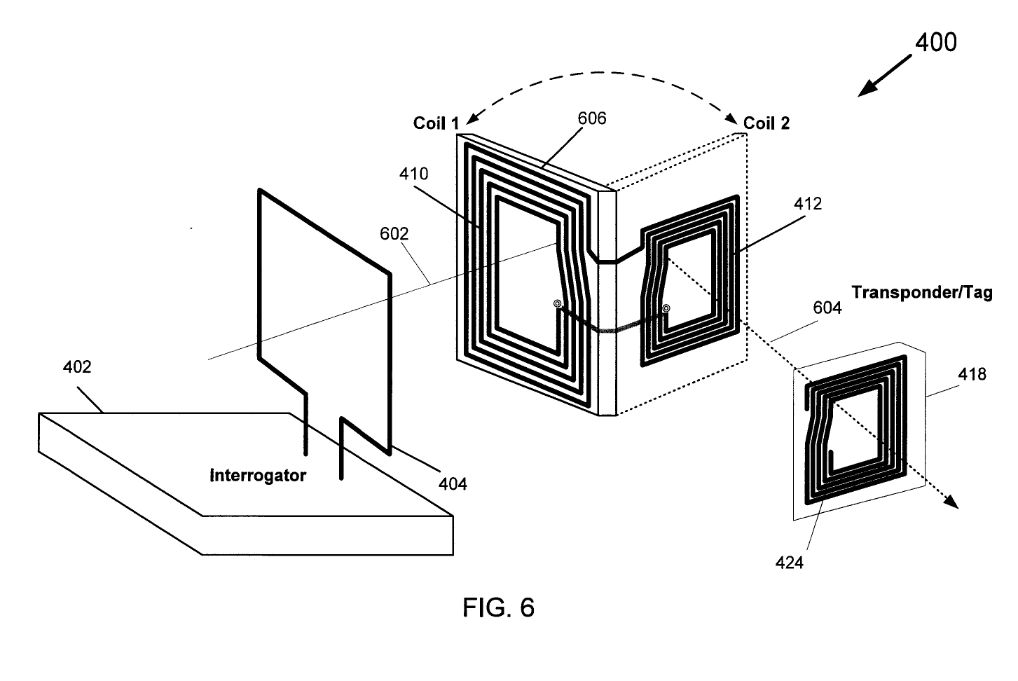

In the example of FIG. 4, antenna 404, intermediate antenna 408, and tag 418 can be said to be aligned with a center orthogonal axis 406. It will be understood that the alignment pictured in FIG. 4 can be preferred as it can result in the optimal magnetic coupling of RF signals 420 with coil 410 and RF signals 422 with antenna 424 included on tag 418. In other embodiments, the various antennas are not necessarily aligned as illustrated in FIG. 4, but it will be understood that the various antennas must be aligned sufficiently to ensure that enough magnetic energy in the various RF signals are sufficiently coupled with the various antennas. Further, as explained in relation to FIG. 6, in certain embodiments intermediate antenna 408 can be configured to bend so that is can change the direction of communication an provide enhanced communication capability when reader 402 and tag 418 are not aligned along a center orthogonal axis as in FIG. 4.

In the example of FIG. 4, communications from interrogator 402 to tag 418 is illustrated but it will be understood that communication from tag 418 to interrogator 402 will operate in a similar manner.

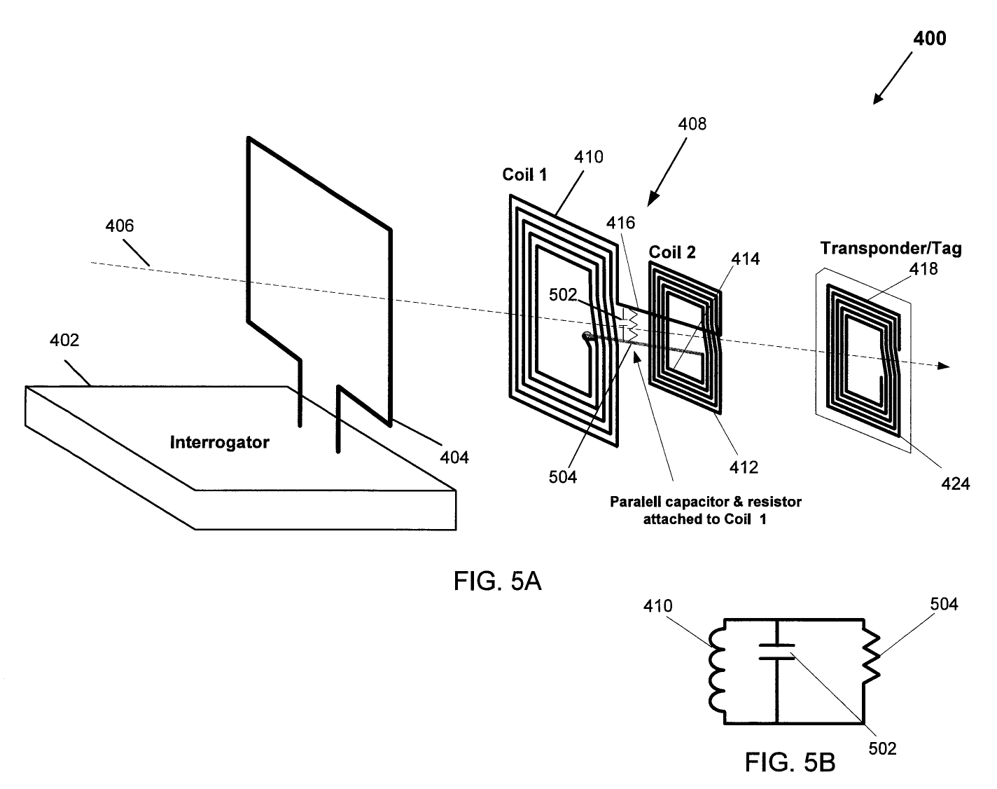

As noted above, coils 410 and 412 must be configured so as to act as resonators at the appropriate frequency. It will be understood, that in order to act as a resonator additional components may need to be coupled with one or both of antennas 410 and 412. For example, FIG. 5A is a diagram illustrating an embodiment of system 400 in which a parallel capacitor 502 and a parallel resistor 504 are coupled with coil 410 in order to create a resonant circuit as required. FIG. 5B is illustrates the schematic equivalent of the resonant circuit formed when capacitor 502 and resistor 504 are coupled with antenna 410. It will be understood that the value of capacitor 502 and resistor 504 will depend on a specific implementation and must be chosen so as to produce a tuned resonant circuit configured to resonate at the appropriate frequency.

In other embodiments, a parallel resistor and/or capacitor can also be coupled with coil 412 in order to produce a resonant circuit tuned to resonate at the appropriate frequency. In certain other embodiments, resistor 504 can be omitted from the tuned resonant circuit coupled with coil 410 and/or coil 412.

As illustrated in FIG. 6, in certain embodiments interrogator 402 and transponder 418 are not aligned along an orthogonal axis. In such embodiments, intermediate antenna 408 can be configured to bend so that it can communicate with interrogator 402 along an axis 602 and with tag 408 along an axis 604. For example, intermediate antenna 408 can be configured to bend around a structure 606 which can be configured to align coil 410 with antenna 404 and coil 412 with antenna 424. This can be achieved via a flexible substrate such as in the embodiments described above.

Thus, antenna 408 can be said to be able to change the direction of communication because it can receive signals from antenna 404 along axis 602 and then retransmit those signals to antenna 424 along axis 604.

It will be understood, that in certain embodiments signals are broadcast from antenna 404 meaning that they travel in all or many directions; however, the portion of the signals broadcast by antenna 404 traveling along axis 602 will be optimally received by coil 410. Similarly, signals broadcast by antenna 424 traveling along axis 604 will be optimally received by antenna 412. Accordingly, antenna 408 configured as illustrated in FIG. 6 can still improve communication between interrogator 402 and tag 418 by redirecting and optimizing the transmissions between the two.

In other embodiments, beam forming or beam shaping can be used so that most, or a significant portion of the transmit energy from antenna 404 travels in the direction defined by axis 602. Similarly, antenna 424 can be configured such that all or a substantial portion of the energy transmitted from antenna 424 travels in the direction defined by axis 604. In such embodiments, communication can be optimized even further.

While certain embodiments of the inventions have been described above, it will be understood that the embodiments described are by way of example only. Accordingly, the inventions should not be limited based on the described embodiments. Rather, the scope of the inventions described herein should only be limited in light of the claims that follow when taken in conjunction with the above description and accompanying drawings.

What is claimed is:

1. A wireless communication system, comprising:
a first communication device;
a second communication device configured to communicate with the first communication device via wireless communication signals; and
an intermediate antenna interposed between the first and second communication devices, the intermediate antenna comprising a first coil configured for optimal coupling with the first communication device and a second coil configured for optimal coupling with the second communication device.

2. The wireless communication system of claim 1, wherein the first communication device is a reader and the second communication device is a tag.

3. The wireless communication system of claim 1, wherein the dimensions of the first coil are close to the dimensions of an antenna included in the first communication device.

4. The wireless communication system of claim 1, wherein the dimensions of the second coil are close to the dimensions of an antenna included in the second communication device.

5. The wireless communication device of claim 1, wherein the first and second coils are approximately the same shape.

6. The wireless communication system of claim 1, wherein the first and second coils are of different shapes.

7. The wireless communication system of claim 1, wherein the first and second coils are tuned to operate at approximately 125 KHz or 134.2 KHz.

8. The wireless communication system of claim 1, wherein the first and second coils are tuned to operate at approximately 13.56 MHz.

9. The wireless communication system of claim 1, wherein the first and second coils are tuned to operate in a UHF frequency band.

10. The wireless communication system of claim 1, wherein the first and second coils are tuned to operate in a microwave frequency band.

11. The wireless communication system of claim 1, wherein the first and second coils are configured to change the direction of communication between the first communication device and the second communication device.

12. The wireless communication device of claim 1, wherein the intermediate device is configured to increase the power in a wireless communication signal received by the second communication device.

13. An RFID system, comprising:
a reader;
a tag configured to communicate with the reader via wireless communication signals; and
an intermediate antenna interposed between the reader and the tag, the intermediate antenna comprising a first coil configured for optimal coupling with the reader and a second coil configured for optimal coupling with the tag, wherein the dimensions of the first coil are close to the dimensions of an antenna included in the reader, and wherein the dimensions of the second coil are close to the dimensions of an antenna included in the tag.

14. The wireless communication device of claim 13, wherein the first and second coils are approximately the same shape.

15. The wireless communication system of claim 13, wherein the first and second coils are of different shapes.

16. The wireless communication system of claim 13, wherein the first and second coils are tuned to operate at approximately 125 KHz or 134.2 KHz.

17. The wireless communication system of claim 13, wherein the first and second coils are tuned to operate at approximately 13.56 MHz.

18. The wireless communication system of claim 13, wherein the first and second coils are tuned to operate in a UHF frequency band.

19. The wireless communication system of claim 13, wherein the first and second coils are tuned to operate in a microwave frequency band.

20. The wireless communication system of claim 13, wherein the first and second coils are configured to change the direction of communication between the reader and the tag.

21. The wireless communication device of claim 1, wherein the intermediate device is configured to increase the power in a wireless communication signal received by the tag.
